(19) United States
(12) Patent Application Publication
(10) Pub. No.: US 2012/0055776 A1
(43) Pub. Date: Mar. 8, 2012

(54) Multi effect distiller with falling film evaporator and condenser cells

(76) Inventor: Peter Feher, Suwanee, GA (US)

(21) Appl. No.: 12/807,321

(22) Filed: Sep. 3, 2010

(51) Int. Cl. B01D 3/02

(52) U.S. Cl. 202/174

(57) ABSTRACT

Multi Effect Distiller (MED) with vertical flat-plate, falling-film heat transfer mechanism. A multitude of alternatively arranged or “checkered”, rectangular shaped evaporator and condenser cells form one layer between two vertical flat plate walls. Multitude of layers—each comprised of alternating evaporator and condenser cells—form the block-shaped MED unit. The evaporator and condenser cells are against each other, sharing common vertical heat transfer walls. The simultaneous propagation of multi effect distillation occurs in two dimensions along the longitudinal vertical plane of the heat exchanger. One end of the distiller is heated, while the other end is cooled.

### TECHNICAL FIELD

The present application relates generally to thermal distillation and more particularly relates to multi effect distillers (MED) used for desalination of water.

### BACKGROUND OF THE INVENTION

Multi-effect Evaporative Distillation is a known technology in the field of large scale water desalination for removal of dissolved solids from undrinkable water sources such as seawater or brackish ground-water. This is a separation process with heat as driving force.

There are two basic principles used in desalination: Membrane Separation and Distillation. Membrane systems use sophisticated semi-permeable porous materials and various driving forces (electrical potential, pressure or temperature gradient) to separate the water molecules from salt ions through the membrane, as the membrane blocks the passage of larger molecules. Distillation systems use heat and/or pressure gradient to vaporize the water and separate it from salt ions and a cooling source to condense the water vapor back to liquid. Desalination systems provide fresh water from seawater on coastal regions and from brackish groundwater in inland areas. Groundwater desalination is also referred as water reclamation.

There are four known basic distillation based desalination processes: Falling Film Evaporation, Flash Vaporization, Vapor Compression and Humidification. The subject of the present application is one of the falling film evaporation based technologies that is considered the most efficient and it will be described in details in the following sections of this application. The other three are described briefly for background purposes: The Flash Vaporization uses differential pressure—driven by the temperature gradient between the heat source and the cooling source—to flash-out the vapor from the liquid water as it passes from a higher to a lower pressure stages. There is a multitude of flash-vessels (or stages) connected in series. These systems are referred as multi-stage flash or MSF. In vapor compression systems, mechanical or thermal jet compression is applied to the water vapor to drive the process and maintain the differential pressure between the evaporation and condensation. With humidification systems, another gas—typically air—is circulated as a working fluid to carry the water vapor from the point of evaporation to the point of condensation. The operation is based on the capacity of air to absorb water and to naturally circulate (rise) if heated. The humidification technologies closely mimic the water-cycle of nature.

The currently known multi effect distillers (MED) are comprised of shell and tube evaporator-condensers units arranged in series, either horizontally or vertically. Each evaporator/condenser unit in the chain process is referred to as one effect. The water vapor from the evaporator of the upstream effect enters to the condenser of the downstream effect. The latent heat of the condensing water vapor is then used to evaporate the water in the next evaporator in the chain and so on. This cascading distillation process is referred to as propagation of evaporative effect from the heat source to the heat sink. Number of effects in a MED process is equal to the number of condenser-evaporator pairs. This number is an expression of the number of times the unit of input (heat) energy is utilized for distillation of water. Higher number of effects results in higher energy efficiency of the system. Typically the shell side of the heat exchanger is the evaporator, while the tube side is the condenser. The known MEDs are expensive because their geometry is complex, the materials required for construction are specialty-alloys and the required manufacturing process is labor-intensive. The horizontal tube-bundles of the condensers are sprayed with seawater such that the outer surfaces of the tubes are partially wetted. This results in relatively low heat-transfer efficiency.

The energy efficiency of thermal desalination is often expressed as Gained Output Ratio (GOR) which is the ratio of the total latent heat of evaporation of the distillate to the input energy. Another often used, similar measure is the performance ratio (PR) which is the ratio of mass flow of distilled water to the mass flow of heating steam at saturated condition.

### SUMMARY OF THE INVENTION

The present application thus describes one embodiment of the invention that may take the form of a two dimensional Multi Effect Distiller (MED) with flat-plate, falling-film, heat transfer mechanism. The invention may be used for distillation of water or any other liquid solution that contains dissolved solute mater. It may be used as concentrator of a solution and for separation of the solvent liquid from the solution. The evaporator and condenser surfaces may be vertically oriented heat transfer planes. The space “sandwiched” between two heat transfer planes may form a layer of evaporator and condenser cells. The rectangular shaped evaporator and condenser cells may be alternatively “checkered” against each other, sharing common heat transfer walls: One evaporator cell may share a common heat transfer wall with one adjacent condenser cell. The evaporator and condenser cells may form a checkered pattern in one layer. Multitude of layers may also form a block shaped desalinator apparatus. A multitude of evaporator and condenser cells may be arranged in an alternating three-dimensional matrix configuration. The position of each cell in the MED block can be defined by 3 numbers for its position in the respective rows, columns and layers of the MED matrix. The simultaneous propagation of multi effect distillation occurs in two dimensions along the longitudinal vertical plane of the heat exchanger. The cells may be filled with water vapor (or vapor of other liquid) such that a portion or all of the cells may be operating below atmospheric pressure. A set of condensing cells on one end of the desalinator may serve as heating cells while a set of evaporating cells may serve as cooling cells. The condensed water vapor collected from the condenser cells may be drained from the unit as desalinated water.

The present application further describes the two dimensional propagation of multi effect distillation process of the invention. The distillation process propagates in two directions simultaneously in the vertical plane of the desalinator device. This vertical plane lies along the length of the desalinator, connecting the hot end with the cold end. The evaporator and condenser cells—in the same plane—form a checkered-pattern layer. The desalination apparatus consists of multitude of layers. The two dimensional propagation of distillation effect in one of these layers is described as follows: In a vertical direction the propagation is from top to bottom: for example from an evaporator cell through a condenser cell below to an evaporator cell below and so on. In a horizontal direction, from the hot to the cold end: for example from a condenser cell through a horizontally adjacent evaporator cell to an adjacent condenser cell and so on.

The present application further describes the flow of saline water (as an example of a solution) in the invention. The saline water flows from top to bottom by gravitation as falling film through the evaporator cells. The saline water enters into a top evaporator cell and flows down on the walls as thin liquid film to the bottom of the cell. Some of the water evaporates (as the cell walls are heated from the adjacent condenser cells) therefore the saline water at the bottom is more concentrated than at the top. The concentrated saline water flows from the bottom of the evaporator cell to the top of the two evaporator cells located below in the adjacent layers on each side of the top evaporator cell through collection-transfer troughs (or gutters). The concentrated saline water enters to the top of the evaporator cell from the adjacent layers from both sides. The concentrated saline water is then mixed with saline feedwater in a mixing bulkhead at the top of the evaporator cell. The feedwater is supplied through distribution nozzles. The saline mixture then is channeled through narrow slots that provide an even flow-distribution of the thin falling film to the walls of the evaporator cells. The flow pattern then repeats itself: The concentrated saline water flows down on the walls and across to the adjacent layers to the top of the two evaporator cells located below on each side of the top evaporator cell . . . and so on.

The present application further describes the flow of brine in the invention. Once the saline concentrate reaches the lowest evaporator cells then the concentrate—or brine is collected at the bottom of the distiller desalinator apparatus. This bottom collection pan is filled with brine. It is closed off from the condenser cells above it and is opened to all lower level evaporator cells. The evaporator cells are only hydraulically connected with each other through the brine pan such that vapor cannot escape, due to sealing effect of the liquid in the pan. Generally speaking the pressure is the same in all of those brine-pan cells that are at the same distance from the hot end of the apparatus (or they are in the same stage of evaporation effects). The liquid flow is largely unrestricted through large openings of the brine-pan across adjacent layers in the same evaporation effect (as these pan cells are all under isobar conditions). The brine flows horizontally in the general direction from the hot end to the cold end of the apparatus. The driving force of the flow is the pressure gradient between consecutive evaporation effects. The liquid flow is restricted in this direction by orifices as the brine cascades from one effect to the next. The collected brine leaves the apparatus at the cold end.

The present application further describes the flow of water vapor and the flow of distilled water. The water evaporation happens in the evaporator cells as they are heated by the condenser cells located in the adjacent layers through shared heat transfer surfaces. The vapor flow from the evaporators is split into two streams. Both streams flow freely within the same layer from the evaporator cell to two of the adjacent condenser cells. Horizontally the vapor flows to the colder condenser cell toward the cold end of the desalinator through vapor passage openings in the wall dividing the evaporator cell from the condenser cell. Vertically the vapor may flow downward to the condenser cell underneath through a vapor passage louver. Therefore most every condenser cell is supplied with water vapor from two directions: a horizontal inflow from the hot-end and an upward vertical inflow. The water vapor is condensed on the walls of the condenser cell that are cooled by the evaporator cells located in the adjacent layers. The distilled, condensed water flows down on the walls of the cell and collects in the bottom of the cell. The distilled water is drained from the condenser cells through drainage tubes to the exterior of the desalinator.

These and other features of the present application will become apparent to one of ordinary skill in the art upon review of the following detailed description when taken in conjunction with the several drawings and the appended claims.

### BRIEF DESCRIPTION OF THE DRAWINGS

FIG. 1 shows a general arrangement of the Multi-Effect Evaporative Desalinator with falling film evaporator and condenser cells arranged in a matrix configuration. It also shows the two-dimensional (vertical and horizontal) propagation of the multi effect evaporative distillation process.

FIG. 2 shows the vertical cross sections of the evaporator and condenser cells. It depicts the flow of saline water and water vapor through the propagation of evaporative distillation effects.

FIG. 3 depicts the horizontal cross section of the brine pan or brine collection bulkhead. It shows the flow path of concentrated brine in the lowest section of desalinator.

FIG. 4 is the detailed drawing of the junction of the evaporator and condenser cells. It depicts the mixing of concentrated saline water—collected from the evaporator cell above in the adjacent layer—with saline feedwater. It also shows the fresh water flash box and the distilled water drainage piping.

FIG. 5 depicts the flow diagram of the desalinator apparatus in an Open-Loop Sea-(or Saline) Water Cooling application.

FIG. 6 depicts the flow diagram of the desalinator apparatus in a Closed, Sea-(or Saline) Water-Loop Cooling application. This configuration is one of the dry-cooling or air cooled applications.

FIG. 7 depicts the flow diagram of the desalinator apparatus in a Closed, Distilled Water-Loop Cooling application. This configuration is also one of the dry-cooling applications.

FIG. 8 is the detailed drawing of the vertical cross section of the “cold” or condenser end of the desalinator in a closed distilled water loop cooling configuration. The final condenser cells are direct contact condensers.

### DETAILED DESCRIPTION

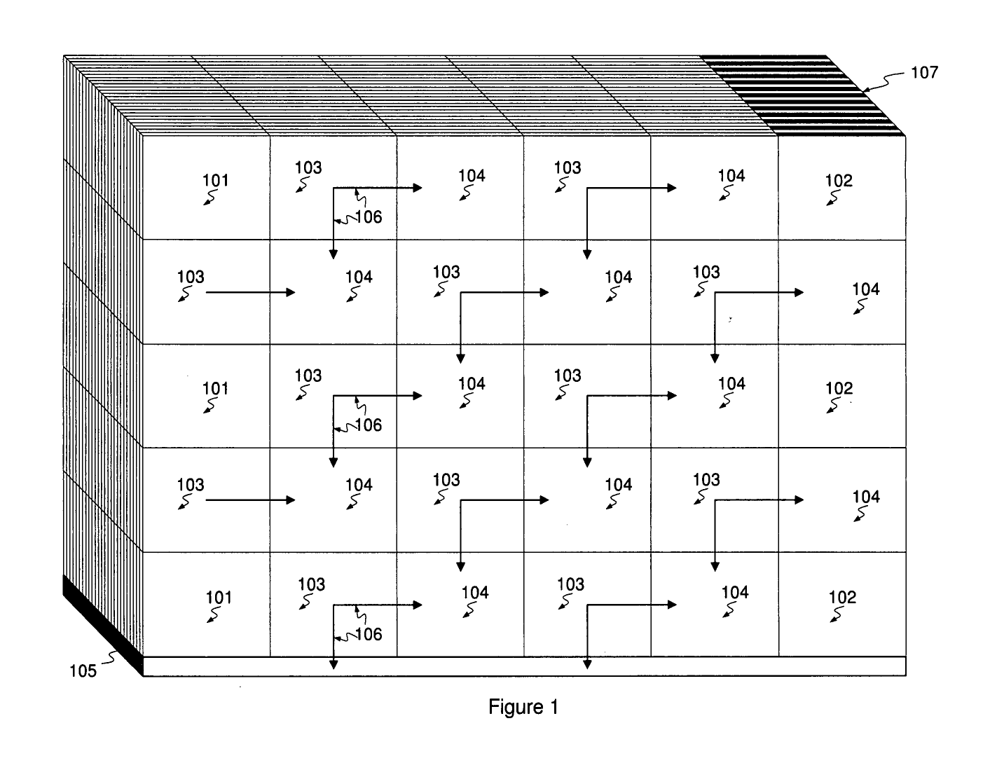

Referring now to the drawings, in which like numerals indicate like elements throughout the several views, FIG. 1 shows an isometric view of one embodiment of the Multi Effect Distiller 107. Water desalination process is used as an example to describe the operation of the system. The heat input takes place in the heating cells 101, on one end of the distiller, while the cooling takes place in the cooling cells 104, at the opposite end. The heating cells 101 are layered alternating with evaporator cells 103, forming a sandwiched structure while the cooling cells are similarly layered alternatively with condenser cells 104. In the mid section of the distiller there are falling film evaporator-103 and condenser cells 104 arranged in a checkered or matrix configuration. The water vapor generated in the evaporator cell 103 leaves and enters into the condenser cell vertically below and into the adjacent condenser cell horizontally forward toward the cooling cells 104. This is a two-dimensional (vertical and horizontal) propagation of the multi effect evaporative distillation process 106.

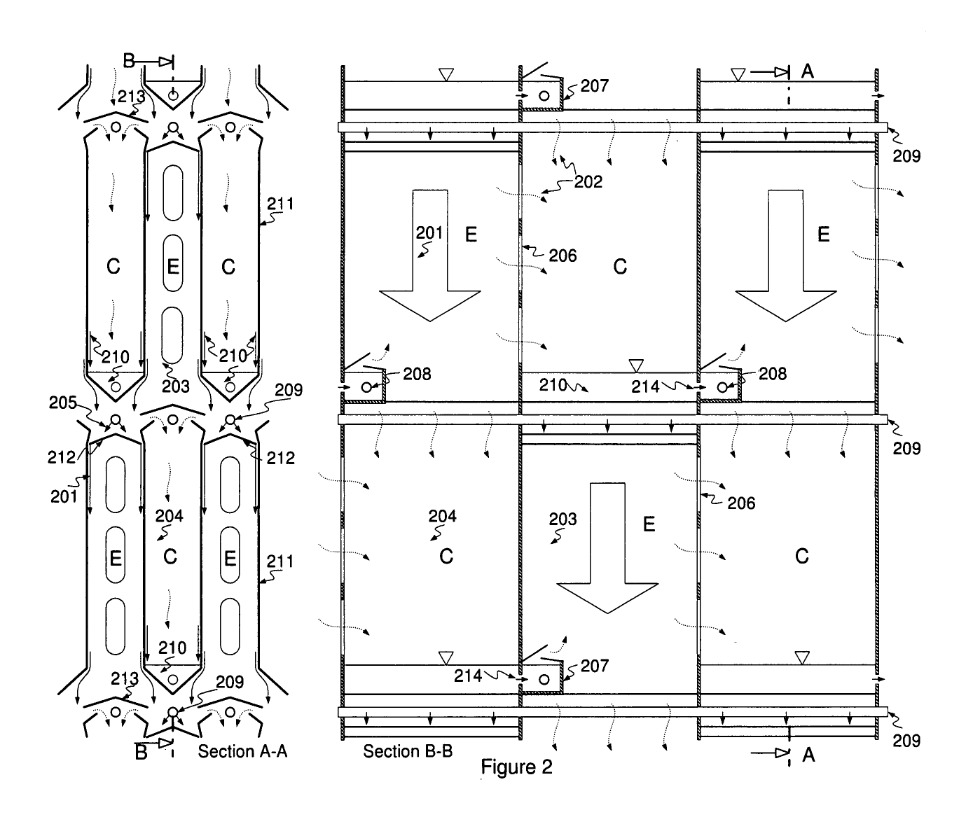

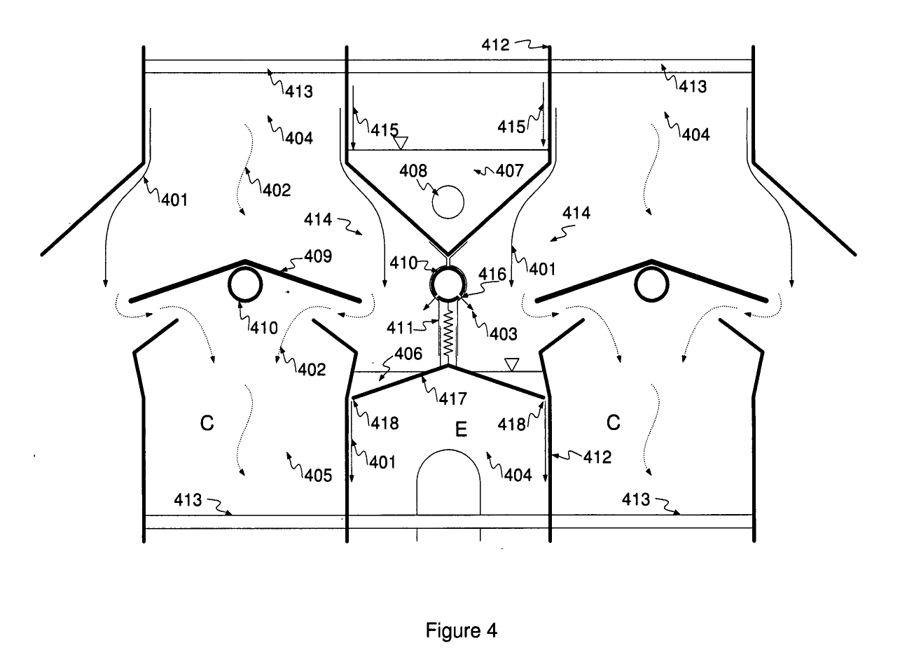

FIG. 2 shows the flow of saline water 201, 205 and water vapor 202 (or other liquid solution and its vapor) through vertical cross sections of the evaporator and condenser cells. The saline feedwater 205 enters through horizontal feedwater pipes 209 that may run through the length of the MED device, parallel with the vertically oriented common sidewalls 211 of the evaporator and condenser cells. The feedwater 205 is mixed with the concentrated saline water 201 flowing from the sidewalls of the evaporator cells. The mixture is then distributed evenly by cap 212 along the top edge of the evaporator cell and flows down on the sidewalls 211 of evaporator cells below. The evaporator cells 203 are heated by the adjacent condenser cells 204 through the metal sidewalls 211. The condenser cells are at slightly higher pressure and temperature than the adjacent evaporator cells. The vapor 202 from the evaporator cells flows to two directions: Downward through the separator cap 213 to the condenser cell below and horizontally and parallel with the sidewalls 211 through the separator end wall openings 206 to the adjacent condenser cell 204. The walls of the condenser cells 204 are cooled by the adjacent evaporator cells through the metal sidewalls 211. The water vapor condenses on the condenser walls and flows down as distilled water 210. The distilled desalinated water is collected in the bottom of the condenser cells and passes through an orifice 214 to a flash-box 207 in the adjacent evaporator cell. The distilled water is then drained through drain pipe 208. Further details of the operation are provided on FIG. 4.

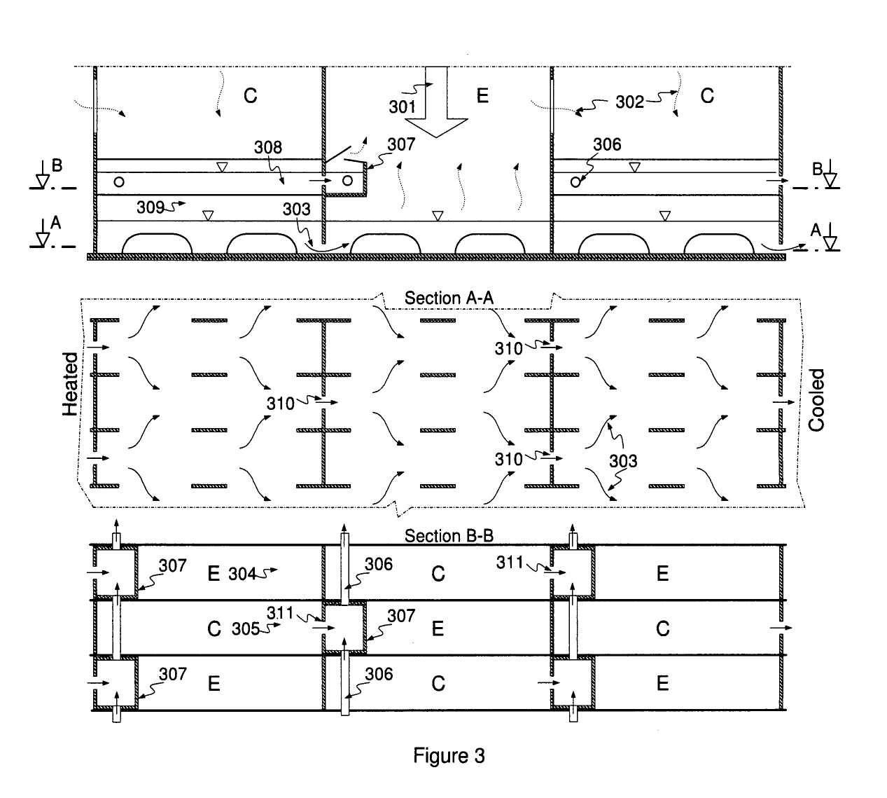

FIG. 3 shows the flow of concentrated liquid solution 301 in the lowest section of distiller. The concentrated solution (or liqueur) 301 cascades down through the evaporator cells to the concentrate pan 309 or collection bulkhead. In case of desalination of saline water, this concentrated liquid is referred to as brine. It flows on the walls of the evaporator cells 304 as falling film until it is collected in the bottom portion of the distiller. The collected brine 303 in the pan 309 is flowing horizontally from the heated end toward the cooled end, through subsequent orifices 310 that are sized to maintain the differential pressure between subsequent compartments of the pan. The brine is drained from the distiller at the cold end. Figure also shows the flow of distilled liquid 305—water in case of desalinator. It is collected in the bottom of the condenser cells and flows through the orifices 311 to the flash box 307 located in the adjacent evaporator cell. From the flash box the distilled water is drained out of the distiller device through drain pipes 306.

FIG. 4 shows the details of one embodiment of the flow distribution and separation system. This is a cross sectional view of evaporator and condenser cells as it relates to the liquid flow distribution and separation of the falling film solution and distilled water. The concentrated liquid brine (liquor) 401 flows down the walls of the evaporator cells 404 and crosses through an opening 414 to the top portion of the evaporator cell bellow in the adjacent layer. The evaporated water (or solvent) vapors 402 flows into the condenser 405. A separator cap 409 prevents the liquid brine from entering into the condenser. The water vapor 402 condenses to liquid distilled water 415 on the walls 412 and it flows down to and collects at the bottom of condenser cell 407 and drains out through the orifice 408. The saline feedwater (or solution feed) is supplied through feedwater pipe 410 and nozzles 413. The feedwater mixes with brine 401 flowing from the evaporator cell above forming a brine mixture 406. The flow distribution of the brine to the walls 412 of the evaporator is accomplished by a distributor plate 417. The flow is controlled by the vertical up and down movement of the plate that results in opening or closing of the gap 418. The weight of the mixed brine pool 406 is countered and balanced by the force of spring mechanism 411. The edges of the distributor plate 417 provide an even thickness of the falling film 401. To prevent pane walls 412 from deflection or implosion—caused by the pressure differential between the evaporator cells 404 and adjacent condenser cells 405—spacers 413 are installed to absorb the forces caused by differential pressure and maintain the cell-wall distances.

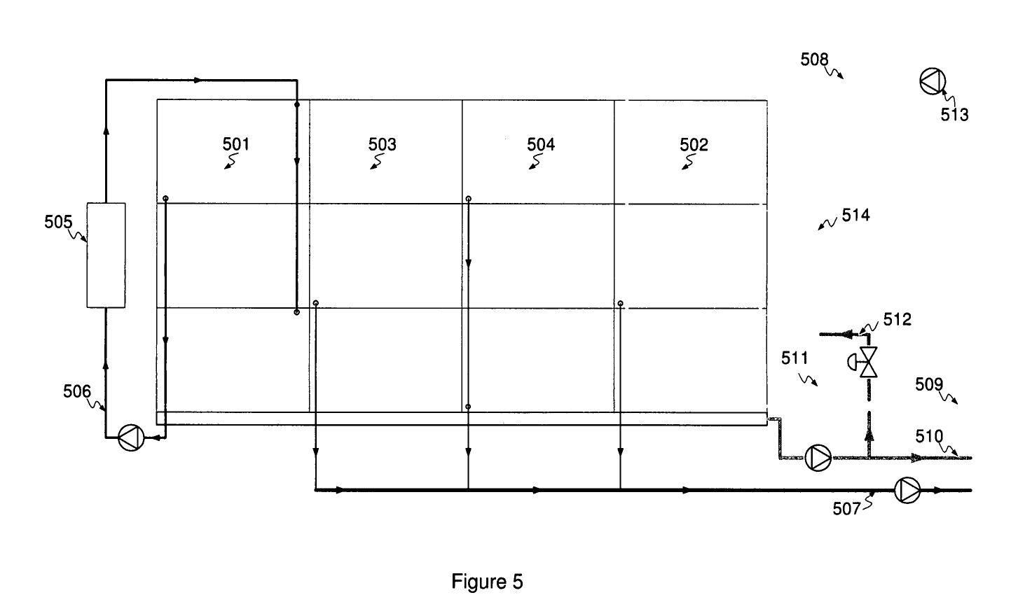

FIG. 5 depicts the flow diagram of the MED matrix distiller apparatus configured for desalination in an open (or once through) cooling-loop application. This configuration is useful in coastal installations where supply of seawater is not limited. As all distillation based processes, the MED system requires significant cooling. If seawater is available for cooling, this open loop could be the most cost effective and energy efficient solution. The heating 501, the cooling 502, the evaporator 503 and condenser 504 cells are arranged in a checkered-matrix configuration. Heating is provided by the heat source 505 through a heating loop 506. Seawater 508 pumped by the main supply pump 513 through the cooling cells 502. Portion of the leaving preheated seawater 511 is used as a portion of the feedstock of the distillation process 514. The balance of the leaving seawater 509 is returned to the sea. The products of the desalination are the distilled water stream 507 leaving the condenser cells 504 and the concentrated brine 510 pumped from the brine collection pan. Portion of the leaving brine stream 512 is recirculated by mixing it with the preheated feedwater 511. This mixture 514 is the feedstock of the distillation process.

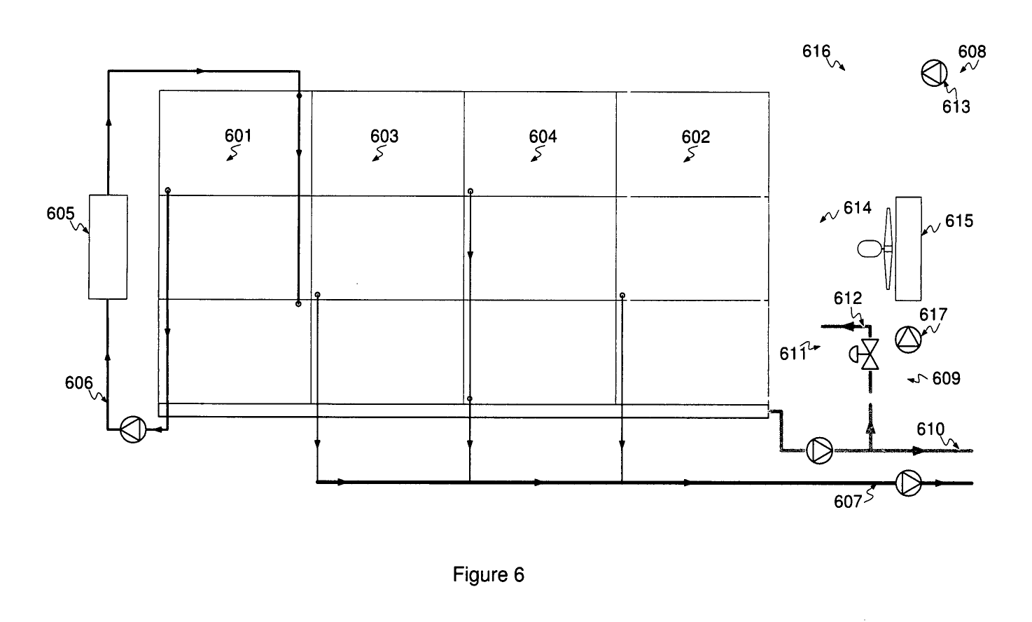

FIG. 6 illustrates the flow diagram of the MED distiller in a closed cooling-loop, useful where supply of saline feedwater is limited and air cooling is required. This configuration is similar to the open loop cooling system shown on FIG. 5 except that the seawater intake 608 is only a process makeup and it is equal to the feedstock flow 611. The closed cooling loop consists of the air cooled heat rejection device 615 (that may be a fin-fan cooler, natural draft cooling tower or other cooling apparatus) and cooling flow 609 circulated by pump 617. The sum of seawater flows 609 and 608 equaling 616 is pumped through the cooling cells 602.

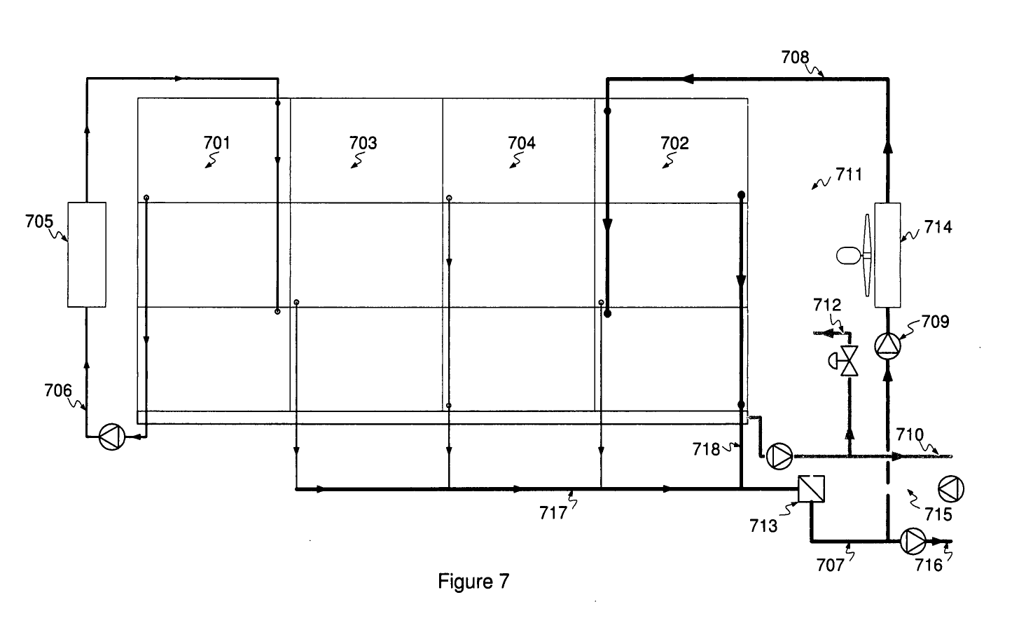

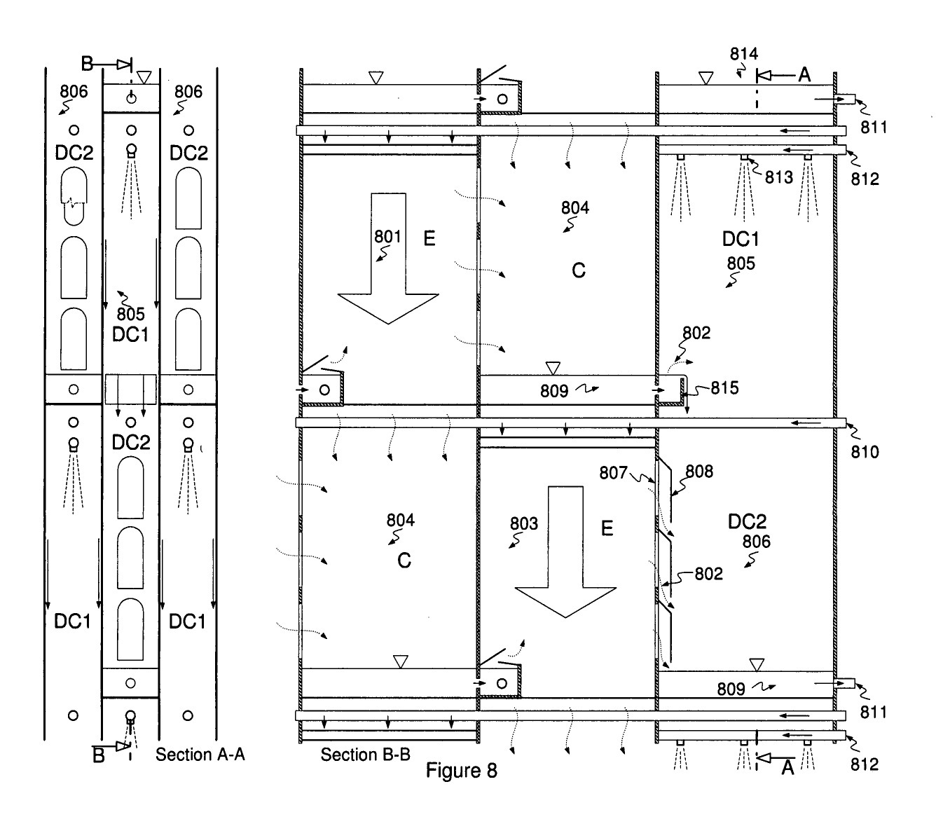

FIG. 7 shows the flow diagram of a novel, direct-contact condenser configuration that uses distilled water in the closed cooling loop. The heating loop 705, 706 is similar to the previously discussed configurations. Saline feedwater 715 enters the system and is preheated in heat exchanger 713 recovering the waste heat from the leaving distilled water. The preheated feedwater is blended with the recirculated brine 712 and the mixed feedstock 711 is fed into the evaporator cells 703 of the MED. The distilled water 717 is mixed with the direct contact condenser cooling water 718 (also a distilled water quality) and the mix 707 is partially cooled after passing through the heat exchanger 713. Portion of the distilled water 708 is further cooled by a heat rejection device 714 (that may be a fin-fan cooler, natural draft cooling tower or other cooling apparatus). The cooled distilled water 708 is used for direct contact condenser cooling. This flow diagram is for interpretation of and in conjunction with FIG. 8.

Further details of the direct contact condenser cooling is shown on FIG. 8. This condenser configuration is significantly different compared to the indirect condenser. In the indirect case the last (cold) column consists of closed loop cooling cells sandwiched between condenser cells. The water in the cooling loop is a saline solution and it removes the heat through the vertical walls, from the condenser cells that collect the distilled water. The cooling and the condenser cells are not connected. In the direct contact condenser configuration—shown on FIG. 8—all cells of the last (cold) column 814 are condensing cells connected only to the distilled water loop. The top, spray-cooled DC1 condenser-cells 805 are simply connected with DC2 condenser-cells 806 positioned below the 805 cells. The 805 and 806 cells form a common, double, condenser cells in series. Cold distilled water is pumped through the spray header pipe 812 and sprayed through nozzles 813 into the cell volume of 805. The fine distilled water droplets fill the volume of both 806 and 805 cells, also creating a falling film on the vertical walls of the cells. The water vapor 802 enters into condenser cell 806 through louver openings from evaporator cells 803. Condensation of the water vapor happens by direct contact on the surfaces of sprayed distilled water droplets. To prevent distilled water splashing into the evaporator cells, the openings 807 are covered with splash preventer louvers 808. Distilled water 809 from the adjacent condenser cell 804 also flows into the flash-box 815, through the flow restrictor orifice as previously described.

I claim:

1. The multi effect distiller with falling-film heat transfer mechanism, wherein a multitude of alternatively arranged, rectangular shaped evaporator and condenser cells form a checkered pattern in one layer between two vertical flat plate walls and wherein the evaporator and condenser cells in adjacent layers are also alternatively arranged in an evaporator-condenser-evaporator etc. manner and wherein the evaporator and condenser cells are arranged against each other, sharing common vertical heat transfer walls and wherein a multitude of vertical layers form a block-shaped distiller unit and wherein the vertical stacks of alternating evaporator condenser cells form columns and the horizontal stacks of alternating cells form rows.

2. The multi effect distiller of claim 1, wherein one horizontal end of the block-shaped distiller unit is heated and the opposite end is cooled and wherein one or a portion or all of condenser cells of the hot end may be used for heating and one or a portion or all evaporator cells on the cold end may be used for cooling.

3. The multi effect distiller of claim 1, wherein the simultaneous propagation of multi effect distillation occurs simultaneously in two dimensions along the vertical plane that lies along the length of the desalinator, connecting the hot end of the distiller with the cold end and wherein in vertical direction the propagation is from top toward bottom through multitude of rows and wherein in horizontal direction, from the hot end toward the cold end through multitude of columns.

4. The multi effect distiller of claim 1, wherein a portion or all of the condensing cells in the first hot end column of the distiller serve as heating cells while a portion or all of the evaporator cells in the last cold end column of the distiller serve as cooling cells and wherein the condensed vapor collected from the condenser cells may be drained from the unit as distilled liquid.

5. The flow pattern of solution wherein the solution flows from top to bottom by gravitation as falling film through multitude of subsequent evaporator cells by alternatively channeling the liquid flow through collection and transfer troughs to the evaporator cells into the adjacent layers and wherein the solution enters into a top evaporator cell and flows down on the walls as thin liquid film to the bottom of the cell and wherein the liquid solution flows from the bottom of the evaporator cell to the top of the two evaporator cells located below in the adjacent layers on each side of the top evaporator cell.

6. The flow pattern of claim 5 wherein the concentrated solution enters to the top of each evaporator cell through collection and transfer troughs from the evaporator cells in the adjacent layers from both sides of the cell and wherein the concentrated solution is mixed with solution feed in a mixing bulkhead at the top of the evaporator cell and wherein the feed is supplied through distribution nozzles and wherein the saline mixture is channeled through narrow slots that provide an even flow-distribution of the thin falling film to both of the heat transfer walls of the evaporator cell.

7. The flow pattern of vapor wherein the vapor generated in each evaporator cell is divided in two and wherein one portion of the vapor passes downwards through the separator cap into the condenser cell below and wherein the other portion of the vapor passes horizontally through the cell separator wall openings to the adjacent condenser cell towards the cold end of the distiller.

8. The flow pattern of collection of the liquid concentrate output wherein the concentrate reaches the lowest evaporator cells wherein the concentrate is collected in the bottom collection pan of the distiller apparatus.

9. The flow pattern of claim 8 wherein the bottom is filled with concentrate and wherein the concentrate in the collection pan flows horizontally in the general direction from the hot end to the cold end of the apparatus and wherein the liquid flow is restricted in this direction by orifices as the concentrate cascades from one effect to the next and wherein the flow is unrestricted in the general direction that is perpendicular to the layers and wherein the collected concentrate leaves the apparatus at the cold end.

10. The direct contact condenser cooling of the multi effect evaporator wherein all or portion of the cells of the cold end column are condenser cells and wherein these condenser cells are connected to the distilled liquid loop as a source of cooling and wherein some or all of the condenser cells are sprayed internally by means of nozzles spraying the internal space of the condenser-cells with cooled distilled liquid and wherein the vapors entering the condenser are in direct contact with the liquid droplets of the distilled liquid and wherein the direct contact of vapor and liquid is the main means of condensation and wherein the sprayed cooling liquid has the same chemical composition as the condensing vapor.
